(19) United States
(12) Patent Application Publication
(10) Pub. No.: US 2009/0005143 A1
(43) Pub. Date: Jan. 1, 2009

(54) Game and method of playing cards with face-up card draws

(76) Inventors: Erica Frohm, Evanston, IL (US); Michael Stallone, Chicago, IL (US); Paul McInemy, Los Angeles, CA (US)

Correspondence Address: Paul E Schaafsma, NovusIP, LLC, Suite 221, 521 West Superior Street, Chicago, IL, 60610-3135, US

(21) Appl. No.: 11/983,906

(22) Filed: Nov. 13, 2007

Related U.S. Application Data
(60) Provisional application No. 60/937,350, filed on Jun. 27, 2007.

(51) Int. Cl. A63F 9/24; A63F 13/00

(52) U.S. Cl. 463/13

(57) ABSTRACT

In accordance with the principles of the present invention, an improved card game is provided. The card game of the present invention comprises dealt cards being face-up cards and draw cards being face-up cards. In one embodiment, the card game of the present invention can be based-on a stud poker game, in which face-up cards are displayed. A player selects a displayed face-up card to add to a hand. The selected displayed face-up card is replaced with another face-up card. The player continues to select displayed face-up cards, and the selected displayed face-up card continues to be replaced with another face-up card, until the hand is complete. In another embodiment, the card game of the present invention can be based-on a draw poker game, in which face-up cards are dealt and face-up replacement cards are displayed. A player chooses cards to discard. The player selects a displayed face-up card to replace a discarded card. Each selected displayed face-up card is replaced with another face-up card. In both embodiments, once all desired cards are selected, the hand is evaluated based on a pay table having payout odds adjusted relative to a face-down card game. This invention may be played using traditional cards or on an electronic gaming machine or a computer.

### RELATED APPLICATIONS

This application is based upon U.S. Provisional Patent Application No. 60/937,350 titled “Game and Method of Playing Poker with Face up Card Draws” filed 27 Jun. 2007.

### FIELD OF THE INVENTION

The present invention relates to card games, both with traditional cards as well as video card games such as played on a computer screen or in a video machine such as found at a casino.

### BACKGROUND OF THE INVENTION

Games of chance provide entertainment to many. Games of chance are more likely to be enjoyable and successful when players are provided with a sense of participation and control, the opportunity to make decisions, reasonable odds of winning, and when the players perceive an improved chance to beat the odds that are normally in favor of a casino.

Poker is a popular type of card game in which players gamble on the superior value of the card combination (“hand”) in their possession. Poker is typically played using a standard 52 card deck of playing cards (or computer-generated facsimiles thereof). In poker, various combinations of the cards have significance based on both the numerical or face value of the cards and their suits. The winner is the one who holds the hand with the highest value according to an established hand-rankings hierarchy. The basic object of poker is for a player to achieve a hand having a higher poker rank than the hands held by the player's opponents. Even when wild cards are used, wild cards only substitute for cards in the defined combinations and do not create new or broader combinations of winning poker hands, although they improve the odds of having a winning hand. Other games that use poker hand rankings may likewise be referred to as “poker”.

Poker has many variations, all following a similar pattern of play. Depending on the variant, hands may be formed using cards which are dealt face-down or a combination of face-up and face-down. Two of the most popular variants are draw poker and stud poker. In draw poker, the player has the opportunity to substitute one or more of the cards from their dealt hand in an effort to improve the value of their hand. In traditional draw poker, the player does not know the value of the substitute cards until after the cards are dealt. Thus, by accepting a substitute card, the player increases chance and lessens control over her game. In stud poker, the player is traditionally dealt a combination of face-up and face-down cards, with betting taking place after each round of dealing.

The introduction of computerized poker games permits players to see the representation of dealt hands on a screen, and the players usually play against a standard pay table retained in memory. For example, conventional computerized poker is a single player game in which a player does not play against a dealer or other players, but rather tries to achieve the highest possible ranking poker hand. A payout schedule is used to determine the amount awarded to the player for achieving specified winning combinations of cards. Poker-hand rankings are used to determine winning card combinations, and a payout schedule contained in the pay table is used to determine the amount awarded to the player for achieving various winning card combinations. The conventional poker hand rankings are based on the probability of that hand occurring, using the normal 52 card deck. The lower the probability of the hand, the higher the ranking. The number of winning card combinations possible in a poker game means that, even at the lower payout value levels a player has a relatively low probability of having a winning hand, even though lower ranked winning hands of cards are the ones which occur most frequently. Also, by drawing substitute cards without knowing their value, the player reduces the amount of control she has over her hand and accepts chance over strategy.

Over time gaming casino patrons can become bored with standard versions of poker games. Casinos are continually looking for new variations of video poker games to continually create renewed interest and attract more players to play poker. It would therefore be advantageous to have new poker games which are similar to conventional poker games in their playing strategy, but which provide for greater player interaction with the game, appear to provide greater opportunities for winning, and provide greater opportunities to increase the amount of strategy used to play the game. Such new games would stimulate renewed interest of experienced players, and the interest of casual players, who will both find the games exciting.

### SUMMARY OF THE INVENTION

A new card game in accordance with the principles of the present invention is similar to conventional poker games in playing strategy, but provides for greater player interaction with the game, appears to provide greater opportunities for winning, and provides greater opportunities to increase the amount of strategy used to play the game. In accordance with the principles of the present invention, an improved card game is provided. The card game of the present invention comprises dealt cards being face-up and draw cards also being face-up.

In one embodiment, the card game of the present invention can be based on a stud poker game, in which face-up cards are displayed. A player selects a displayed face-up card to add to a hand. The selected displayed face-up card is replaced with another face-up card from the deck. The player continues to select displayed face-up cards, and the selected displayed face-up card continues to be replaced with another face-up card from the deck, until the hand is complete.

In another embodiment, the card game of the present invention can be based-on a draw poker game, in which face-up cards are dealt and face-up replacement cards are displayed. A player chooses from none to all cards to discard. The player selects a displayed face-up card to replace a discarded card. Each selected displayed face-up card is replaced with another face-up card from the deck. In both embodiments, once all desired cards are selected, the hand is evaluated based on a pay table having payout odds adjusted relative to a face-down card game. This invention may be played using traditional cards or on an electronic gaming machine or a computer.

### BRIEF DESCRIPTION OF THE DRAWING

The foregoing aspects and many of the advantages of the present invention will be more readily appreciated as the same becomes better understood by reference to the following detailed description, when taken in conjunction with the accompanying drawings, wherein:

FIG. 1 is a representative opening screen for a stud-type poker game in accordance with the principles of the present invention.

FIG. 2 is a flow chart for a stud-type poker game in accordance with the principles of the present invention.

FIG. 3 is a flow chart for a draw-type poker game in accordance with the principles of the present invention.

FIG. 4 is an initial screen shot for a draw-poker game in accordance with the principles of the present invention.

FIG. 5 is a draw/discard screen shot for a draw-type poker game in accordance with the principles of the present invention.

### DETAILED DESCRIPTION OF A PREFERRED EMBODIMENT

The present invention relates to card games, both with traditional cards as well as video card games such as played on a computer screen or in a video machine such as found at a casino. In accordance with the principles of the present invention, desirable elements of conventional poker games are combined with a non-obvious improvement that gives a player more sense of participation and control, the opportunity to make decisions, reasonable odds of winning, and player perception of a chance to beat odds that are normally favor a casino. In accordance with the principles of the present invention, a variation on traditional poker games is provided where face-up cards are dealt and draw cards also are face-up instead of face-down, with pay tables adjusted accordingly. Giving the player the ability to choose from a set of known cards to complete the player's hand gives the player the sense that they have a better chance of winning the poker game, although the odds are adjusted in the pay table for the game. The class of poker games in accordance with the principles of the present invention is non-limitingly referred to herein as “Race Poker”.

While two embodiments of such “Race Poker” are described herein—“Race Draw Poker” and “Race Stud Poker”—it will be appreciated that the principles of the present invention may be easily applied to many variations of poker, including but not limited to, for instance, Texas Hold-em, Omaha Hold-em, High-Low, Canadian Stud, Mexican Stud, Crocodile Stud, Telesina, Scandinavian Stud, Up Down variants, Anaconda, Howdy-Doody, Jacks to Open, Trips to Win, Trees, All for One, One for All, Pick a Partner, Threes, Don Juan, Triple Draw, Monkey Love, and any other variations that are now known or are developed in the future.

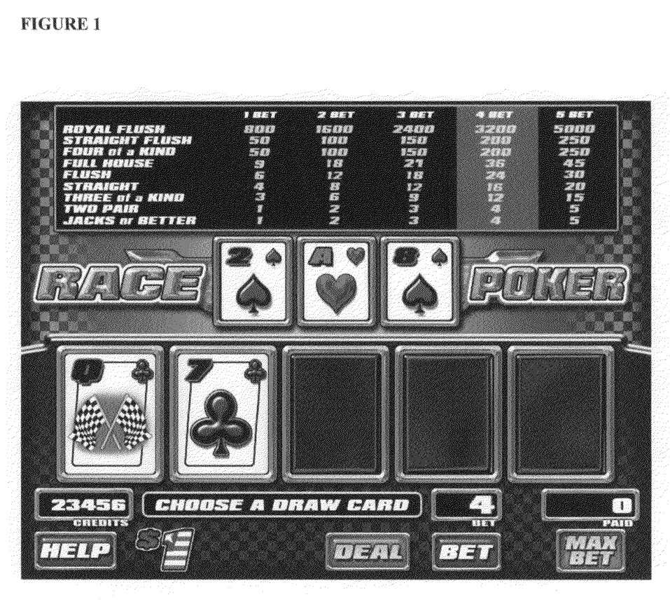

A typical gaming machine has other elements, not shown in the Figures because they are well known in the art and not part of the present invention, such as for example a game housing or console having a front panel with a display screen (shots of which are depicted in FIGS. 1, 4, and 5); coin, token, paper money, and/or debit card slots; a flashing light on the top of the housing to announce a winning jackpot; and other controls which are well-known in the art. Game instructions also can be included on the front panel of the game housing to instruct a player as to how to play the “Race Poker” game. In addition, preferably instructions or flashing lights on the video display screen indicate what action is required by the player at particular times during game play. These other elements form no specific part of the present invention, but machines containing these elements may be used to play the games of the invention.

The screen shots shown in FIGS. 1, 4 and 5 indicate touch screen operation. The use of touch screen technology with gaming machines is well known in the video gaming art. As specific locations on the screens are touched during game play the touch is sensed by a computer and appropriate game action is taken as is described hereinafter. The locations and types of buttons and elements of screen display may vary and all variants are included within the scope of the invention.

It is assumed throughout that a player of the electronic game variation is utilizing and has inserted cash or a debit card (not shown) into an appropriate slot (not shown) in the gaming machine. The debit card has stored thereon a numerical indication of a number of credits which the player may use to bet and play games. Bets are debited from the stored amount, and winnings are added to the stored amount. When a player first inserts their debit card or cash into the appropriate slot in a gaming machine, the number of credits currently held by the player is read from the debit card and can be displayed on the screens. The number of credits increases and decreases during the course of playing games as a player places bets, wins, and loses.

After a player inserts their debit card or cash into an appropriate slot in the gaming machine (both not shown) to indicate that they wish to play the “Race Poker” game, the number of credits the player has (as indicated by the number of credits stored on the player's debit card if they use a debit card) is read from the card and displayed as described in the previous paragraph. More particularly, a player can physically touch ones of the displayed ‘Bet’ buttons on video display screen to place one or more bets on the game, up to a maximum of bets. Each time the player touches a ‘Bet’ button it is sensed by the touch-screen technology, and the number of bets displayed on display is changed accordingly. Technology may be included for decreasing as well as increasing bets during the play of the game, or to select a maximum bet, as shown on FIGS. 1, 4, and 5. In the Examples of the invention described herein it is assumed that only a set maximum of bets may be placed on any single game, although this number is arbitrary. This matches information in the example pay tables, which are described further below.

When the player is satisfied with the initial wager, they may press the ‘Deal’ button to begin game play. In one embodiment, the poker game of the present invention can be based-on a stud poker game, in which face-up cards are displayed. A player can then select a displayed face-up card to add to a hand. The selected displayed face-up card is replaced with another face-up card from a card deck, either real or electronic. The player continues to select displayed face-up cards, and the selected displayed face-up card continues to be replaced with another face-up card from a card deck, until the hand is complete.

In another embodiment, the poker game of the present invention can be based-on a draw poker game in which face-up cards are dealt and face-up replacement cards are displayed. A player can choose cards to discard, in one example embodiment from none to all. The player can then select a displayed face-up card to replace a discarded card. Each selected displayed face-up card is replaced with another face-up from a card deck. In both embodiments, once all desired cards are selected, the hand is evaluated based on a pay table having payout odds adjusted relative to a face-down card game. This invention may be played using traditional cards or on an electronic gaming machine or a computer.

### Example 1

### Electronic “Race Stud Poker”

In one embodiment in accordance with the present invention, the improvement is achieved by allowing the player to construct their poker hand one card at a time by selecting initially from a set of three face-up draw cards, an example of which is shown in FIG. 1. When the player selects a draw card, the selected card is placed in the player's poker hand and replaced in the draw card set with another face-up card from the deck. Thus, in the FIG. 1 example the player has previously selected the queen of clubs and the seven of clubs, and can select the next card form the two of spades, ace of hearts, and eight of spades. In this example embodiment of the invention, the play can be based-on standard five-card stud, except that the player has a degree of control over the construction of their hand in that they can pick from face-up cards instead of traditional face-down cards. The construction of the player's hand one card at a time gives the appearance of increased probability of winning, although the odds are adjusted in the pay table for the game.

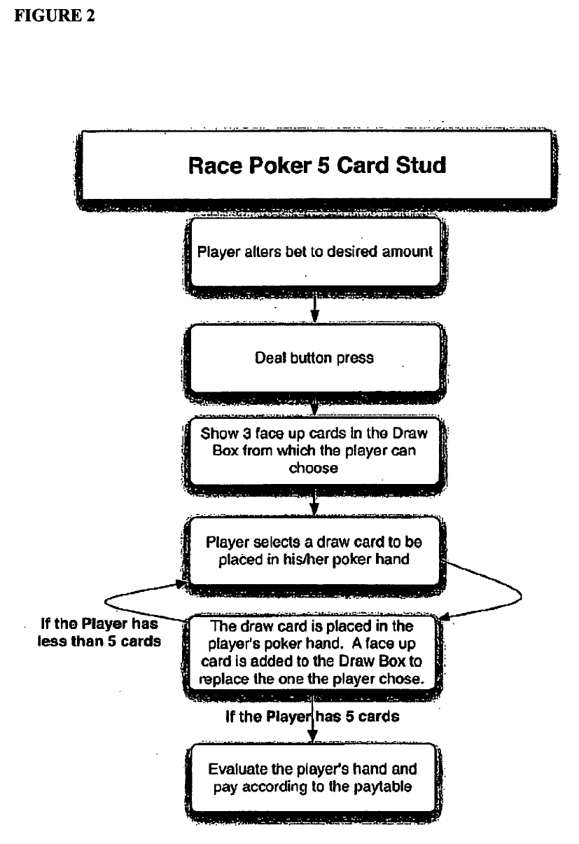

Referring to FIG. 2, a flow chart for an electronic version of the game describes the process of constructing a five-card “Race Stud Poker” hand using the drawing method of the present invention. As is depicted in the flow chart, the player bets, then is allowed to choose an initial card from a set of face-up cards, in this example embodiment three as shown in FIG. 1. The player selects an initial card, and that card is replaced from the deck of cards. While in this example a three-card draw box is shown, any size draw box of two or more cards may be used provided the pay table is adjusted accordingly for the lower player risk associated with a larger face-up draw box or the higher player risk associated with a smaller face-up draw box. This process is repeated until the player has a full hand, which in this example is five cards. The hand is then evaluated for payout according to an appropriate pay table.

### Example 2

### Electronic “Race Draw Poker”

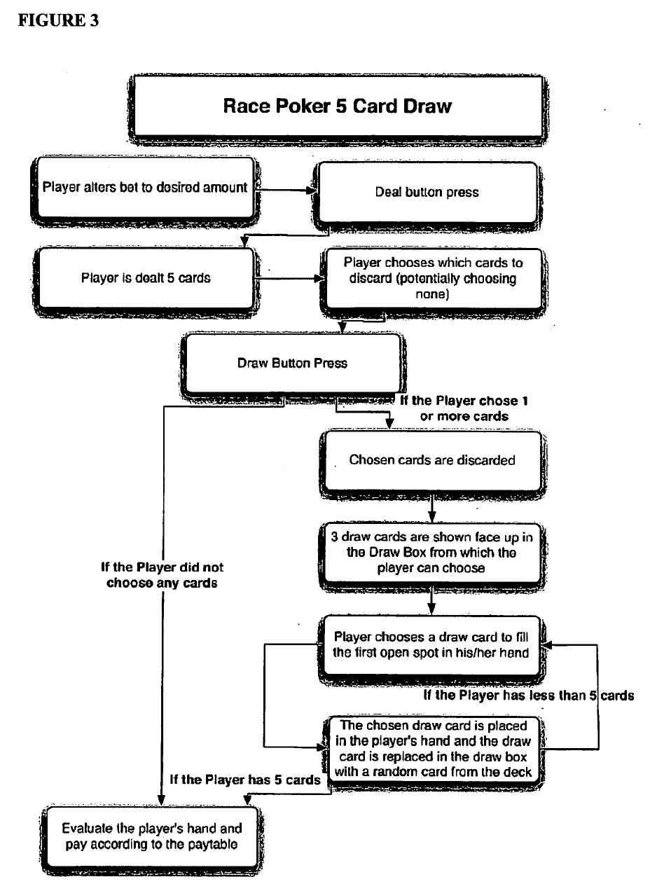

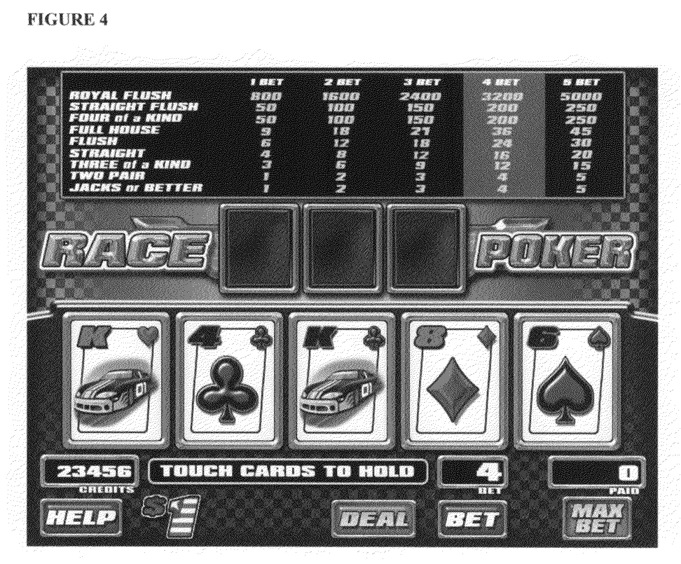

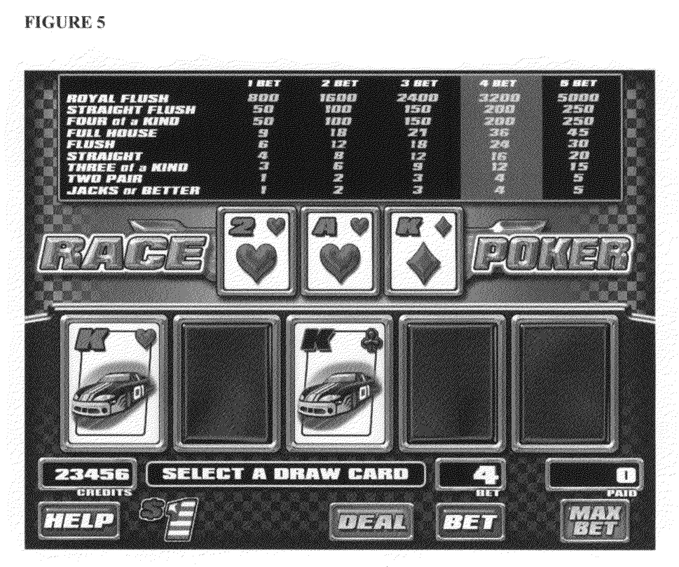

Referring to FIG. 3, a flow chart shows a “Race Draw Poker” game in accordance with the principles of the present invention is seen. FIG. 4 shows the initial screen for the draw poker variation described generally in this example embodiment. The player enters an initial bet, and the player is dealt a hand of face-up cards, in this example 5 although the number of initial cards dealt may vary for other embodiments. In the FIG. 5 example the player has been dealt the king of hearts, the four of spades, the king of spades, the eight of diamonds, and the six of spades. As depicted in FIG. 5, the player can then choose cards to discard, in this example embodiment from none to all cards to discard. In the example of FIG. 5, the player chose to discard three cards—the four of clubs, the eight of diamonds, and the six of spades—hoping to improve on the pair of kings. Face-up cards from which to choose are then shown in the draw box as seen in FIG. 5 (a two of hearts, an ace of hearts, and a king of diamonds), from which the player selects to replace the discarded cards, one at a time. In this example, the player can select the king of diamonds, thus improving the hand to three kings. In addition, in accordance with the pay tables described in detail below, the player has thus increased her credits by 12 on a four credit bet, as highlighted in the pay table. Again, while in this example a three-card draw box is shown, any size draw box of two or more cards may be used provided the pay table is adjusted accordingly for the lower player risk associated with a larger face-up draw box or the higher player risk associated with a smaller face-up draw box.

For each card removed from the draw box and placed into the hand, that card is replaced from the deck of cards. Once all desired cards are replaced, the player's hand is then evaluated according to the pay table developed for the game of the invention. Once again, there are many variations of pay tables that are suitable for use with the invention

the pay table must simply balance the player's willingness to continue play with odds that are acceptable to the casino.

There are many variations of pay tables that are suitable for use with the invention

the pay table represents an appropriate balance between the player's willingness to continue play and odds that are acceptable to the casino. Example pay tables are set forth below. Comparing Table 1 and Table 2, the difference between a pay table for a five-card “Race Poker” example of the invention described herein and a pay table for a conventional electronic poker game are seen, with Table 1 a conventional pay table and Table 2 depicting an example of a pay table for the five-card “Race Poker” of the present invention.

TABLE 1
Standard Payouts

| | 1 Bet | 2 Bet | 3 Bet | 4 Bet | 5 Bet |
|---|---|---|---|---|---|
| Royal Flush | 250 | 500 | 750 | 1000 | 4000 |
| Straight Flush | 50 | 100 | 150 | 200 | 250 |
| Four of a Kind | 25 | 50 | 75 | 100 | 125 |
| Full House | 8 | 20 | 30 | 40 | 50 |
| Flush | 5 | 16 | 24 | 32 | 40 |
| Straight | 4 | 12 | 18 | 24 | 30 |
| Three of a Kind | 3 | 8 | 12 | 16 | 20 |
| Two Pair | 2 | 4 | 6 | 8 | 10 |
| Jacks or Better | 1 | 2 | 3 | 4 | 5 |

TABLE 2
“Race Poker” Payouts

| | 1 Bet | 2 Bet | 3 Bet | 4 Bet | 5 Bet |
|---|---|---|---|---|---|
| Royal Flush | 800 | 1600 | 2400 | 3200 | 5,000 |
| Straight Flush | 50 | 100 | 150 | 200 | 250 |
| Four of a Kind | 50 | 100 | 150 | 200 | 250 |
| Full House | 9 | 18 | 27 | 36 | 45 |
| Flush | 6 | 12 | 18 | 24 | 30 |
| Straight | 4 | 8 | 12 | 16 | 20 |
| Three of a Kind | 3 | 6 | 9 | 12 | 15 |
| Two Pair | 1 | 2 | 3 | 4 | 5 |
| Jacks or Better | 1 | 2 | 3 | 4 | 5 |

It is thus seen that because the odds of a player “drawing” a “royal flush” are less in this “Race Draw Poker” game relative to conventional draw poker, the payout for “royal flush” in the present invention is greater than the payout for a conventional game; in this example, 5,000 verses 4,000. This is because in a standard draw poker game a player is dealt five cards. The player then decides what cards to hold and discards the others; which are replaced by cards from the top of the deck. In “Race Draw Poker” the player is shown three face-up cards and decides to which card to place into the hand. Once a player has select a card it is replaced with a card from the top of the deck; this continues until the hand is completed. In standard draw poker the odds of getting a royal flush increase because the player has the potential to see more cards (10) verses Race Draw Poker where the most cards the player can see is seven; thus the difference in payout. Of course, a different pay table could be developed for each variation of the game reflecting the varying odds, such as the size of the draw box, if wild cards are allowed, etc.

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A poker game comprising dealt cards being face-up cards and draw cards being face-up cards.

2. The poker game of claim 1 further wherein payout odds are different relative to a face-down card game of the same type of poker game.

3. The poker game of claim 1, further wherein the game is electronic and adapted for a computer or gaming console.

4. The poker game of claim 1 further wherein face-up cards are dealt; face-up replacement cards are displayed; a player chooses which cards to discard; the player selects a displayed face-up card to replace a discarded card; each selected displayed face-up card is replaced with another face-up card; and once all desired cards are replaced, the hand is evaluated.

5. The poker game of claim 4 further wherein a player chooses from none to all cards to discard.

6. The poker game of claim 4 further wherein the hand is evaluated based on a pay table having payout odds different relative to a face-down card game of the same type of poker game.

7. The poker game of claim 1 further wherein face-up cards are displayed; a player selects a displayed face-up card to add to a hand; the selected displayed face-up card is replaced with another face-up card; the player continues to select displayed face-up cards, and the selected displayed face-up card continues to be replaced with another face-up card until the hand is complete; and once all desired cards are selected, the hand is evaluated.

8. The poker game of claim 7 further wherein the hand is evaluated based on a pay table having payout odds adjusted relative to a face-down card game.

9. A method of card play comprising:
displaying face-up cards;
a player selecting a displayed face-up card to add to a hand;
replacing the selected displayed face-up card with another face-up card;
the player continuing to select displayed face-up cards, and the selected displayed face-up card continuing to be replaced with another face-up card until the hand is complete; and
once all desired cards are selected, evaluating the hand.

10. The method of card play of claim 9 further including evaluating the hand based on a pay table.

11. The method of card play of claim 10 further including paying based on a corresponding value in a pay table having payout odds different relative to a face-down card game of the same type of card game.

12. The method of card play of claim 9 further including displaying face-up replacement cards from two to the number of cards in a deck.

13. The method of card play of claim 9 further including displaying face-up replacement cards in a draw box.

14. The method of card play of claim 9 further including selecting five displayed face-up card to complete the hand.

15. The method of card play of claim 9 further wherein the card game is played electronically.

16. A method of card play comprising:
dealing face-up cards;
displaying face-up replacement cards;
a player choosing cards to discard;
the player selecting a displayed face-up card to replace a discarded card;
replacing each selected displayed face-up card with another face-up card; and
once all desired cards are replaced, evaluating the hand.

17. The method of card play of claim 16 further including a player choosing from none to all cards to discard.

18. The method of card play of claim 16 further including evaluating the hand based on a pay table.

19. The method of card play of claim 18 further including paying based on a corresponding value in a pay table having payout odds different relative to a face-down card game of the same type of card game.

20. The method of card play of claim 16 further including displaying face-up replacement cards from two to the number of cards in a deck.

21. The method of card play of claim 16 further including displaying face-up replacement cards in a draw box.

22. The method of card play of claim 16 further wherein the card game is played electronically.
